(19) United States
(12) Patent Application Publication
(10) Pub. No.: US 2016/0247201 A1
(43) Pub. Date: Aug. 25, 2016

(54) Advertisement Selection and Pricing Based in Part on User Interest Inferred from User Interaction

(71) Applicant: REALITYGATE (PTY) LTD, Stellenbosch (ZA)

(72) Inventors: Jan Pool, Stellenbosch (ZA); Adri Smuts, Durbanville (ZA); Willem Morkel Van Der Westhuizen, Stellenbosch (ZA); Hendrik Frans Verwoerd Boshoff, Stellenbosch (ZA)

(21) Appl. No.: 15/028,329

(22) PCT Filed: Oct. 21, 2014
(86) PCT No.: PCT/IB14/02939

§ 371 Date: Apr. 8, 2016

Related U.S. Application Data
(60) Provisional application No. 61/894,268, filed on Oct. 22, 2013.

(51) Int. Cl. G06Q 30/02

(52) U.S. Cl. CPC G06Q 30/0267; G06Q 30/0275

(57) ABSTRACT

A client device presents one or more advertisements via a user interface presented by a client device. When the client device receives input from the user interacting with the user interface, a direction of motion of the input is determined and used to determine the user's measure of interest in various advertisements. For example, a direction of movement of the input relative to an advertisement determines the user's measure of interest in the advertisement. Based on the measure of interest in various advertisements, one or more additional advertisements are selected and prices charged to one or more advertisers associated with presented advertisements are determined.

### BACKGROUND

This invention relates generally to advertisement presentation, and more specifically to selecting and pricing advertisements based at least in part on observed user interactions.

Increasingly, users access content through client devices having touch sensitive displays. As these client devices become increasingly more portable, their display areas have also become smaller. With smaller display areas, presenting content items likely to interest users is increasingly important for content providers to maintain user engagement.

However, content providers often present advertisements along with content items to obtain revenue from advertisers. Presenting users a large number of advertisements or with advertisements for products or services in which a user is uninterested may reduce user interaction with a content provider. While advertisements are often associated with targeting criteria to limit presentation of the advertisements to users likely to be interested in the advertisements, these targeting criteria often make use of limited information describing user interests.

### SUMMARY

To increase likelihood of a user interacting with a presented advertisement, a user's interest may be inferred from interactions with a user interface presented by a client device. In one embodiment, a pointer representing a position of a received user interaction with the user interface is determined and attributes of the pointer are used to infer a user's interest in advertisements presented by the user interface. Based on the inferred user interest, one or more additional advertisements may be selected and presented to the user via the user interface.

For example, a user interface presents a plurality of advertisements and an application associated with the user interface determines a user's interest in selecting an advertisement based on a direction of a pointer relative to the advertisement, a distance between the pointer and the advertisement, or the size of the advertisement (e.g., if the advertisement's size changes based on the movement of the pointer). Based on the determined user interest in various advertisements, advertisements may be scored or prioritized. For example, a higher priority may be associated with an advertisement associated with larger measures of user interest, or scores associated with various advertisements are proportional to measures of user interest in the advertisements. For example, scores are associated with various presented advertisements based on movement of the pointer towards different ads. In one embodiment, a threshold interest is specified and a score is associated with advertisements having at least the threshold interest. One or more additional advertisements may be selected for presentation to the user based at least in part on the scores associated with the presented advertisements. For example, one or more additional advertisements having one or more characteristics matching, or similar to, characteristics of presented advertisements with at least a threshold score or having the highest scores are selected for presentation to the user.

Additionally, advertisement pricing may be modified to account for additional information about a user's interest in accessing an advertisement inferred from the user's interaction with a user interface. In one embodiment, a user interface presents a plurality of advertisements to a user and an application associated with the user interface detects movement of a pointer corresponding to a user interaction with the user interface. The pointer may be a user contacting a portion of the user interface via a touch-sensitive display or accessing a portion of the user interface via another suitable input device. Based on the detected movement, a display status of a presented advertisement is modified. The display status of an advertisement specifies one or more characteristics of advertisement presentation. Examples of a display status include a size of an advertisement, a position of an advertisement in the user interface, and a boundary associated with selection of an advertisement. Based on the adjusted display status of the advertisement, a pricing function is applied to the advertisement to determine a price charged to an advertiser associated with the advertisement.

Various pricing functions may be applied to an advertisement based on the advertisement's display status. For example, a scalar between 0 and 1 is determined that represents the user's interest in the advertisement based on movement of a pointer towards the advertisement; a bid amount associated with the advertisement is multiplied by the scalar to determine the price charged to an advertiser associated with the advertisement. As another example, the bid amount associated with the advertisement charged to the advertiser if the pointer reaches a threshold distance from the advertisement. Alternatively, if the pointer reaches a threshold distance from the advertisement, the advertiser is charged a price based on a bid amount associated with the advertisement multiplied by a scalar value determined from the movement of the pointer towards the advertisement. Other pricing functions may be applied in various embodiments.

### BRIEF DESCRIPTION OF THE DRAWINGS

FIG. 1 is a block diagram of a client device, in accordance with an embodiment of the invention.

FIG. 2 is a flowchart of a method for selecting advertisements for presentation to a user, in accordance with an embodiment of the invention.

FIG. 3 is a flowchart of a method for determining an amount of compensation charged to an advertiser associated with an advertisement, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

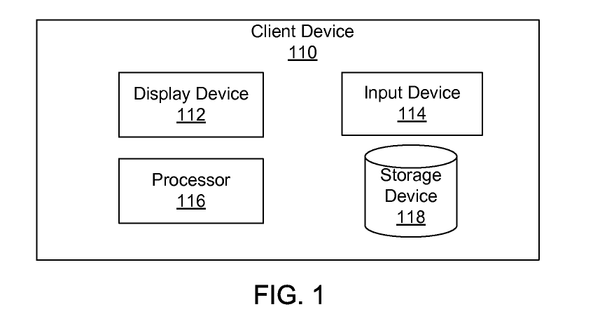

FIG. 1 is a block diagram of a client device 110. The example client device 110 shown by FIG. 1 includes a display device 112, one or more input device 114, a processor 116, and a storage device 118. However, in alternative configurations, the client device 110 may include different and/or additional components than those shown in FIG. 1.

The client device 110 is one or more computing devices capable of receiving user input as well as transmitting and/or receiving data. In one embodiment, the client device 110 is a conventional computer system, such as a desktop computer or a laptop computer. Alternatively, the client device 110 may be a device having computer functionality, such as a personal digital assistant (PDA), a mobile telephone, a smartphone or another suitable device. In one embodiment, the client device 110 executes an application allowing a user of the client device 110 to interact with a content provider or a third party system. For example, an application executing on the client device 110 communicates instructions or requests for content items to a content provider. As another example, the client device 110 executes a browser that receives and presents content from a content provider via the display device 112. In another embodiment, the client device 110 interacts with a content provider through an application programming interface (API) running on a native operating system of the client device 110, such as IOS® or ANDROID™.

A display device 112 included in the client device 110 presents content items to a user of the client device 110. Examples of the display device 112 include a liquid crystal display (LCD), an organic light emitting diode (OLED) display, an active matrix liquid crystal display (AMLCD), or any other suitable device. Different client devices 110 may have display devices 112 with different characteristics. For example, different client devices 112 have display devices 112 with different display areas, different resolutions, or differences in other characteristics.

One or more input devices 114 included in the client device 110 receive input from the user. Different input devices 114 may be included in the client device 110. For example, the client device 110 includes a touch-sensitive display (a “touchscreen”) for receiving input data, commands, or information from a user. Using a touch-sensitive display allows the client device 110 to combine the display device 112 and an input device 114, simplifying user interaction with presented content items. In other embodiments, the client device 110 may include a keyboard, a trackpad, a mouse, or any other device capable of receiving input from a user. Additionally, the client device 110 may include multiple input devices 114 in some embodiments. Inputs received via the input device 114 may be processed by an application associated with a content provider and executing on the client device 110 to allow a client device user to interact with content items presented by the content provider.

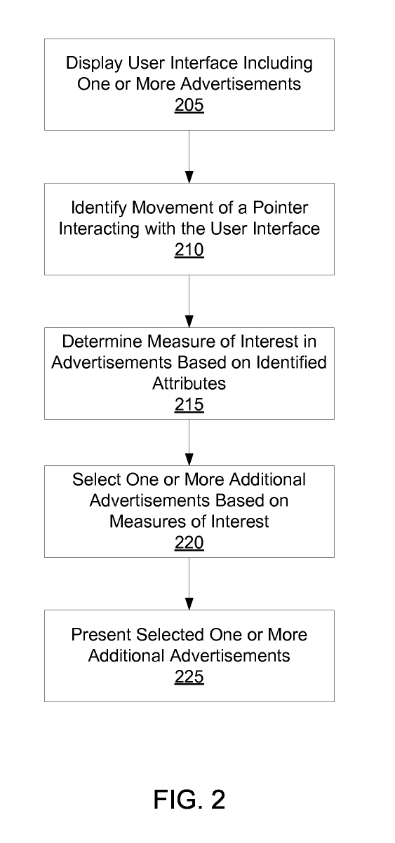

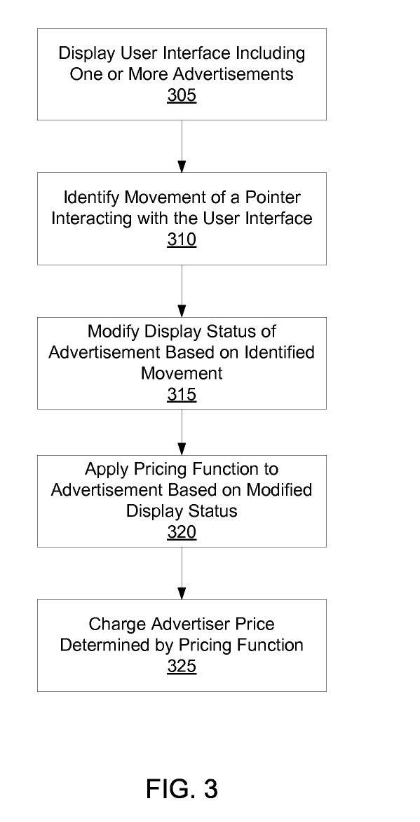

The client device 110 also includes a processor 116, which executes one or more instructions stored in a storage device 118 to provide various functionalities to a user of the client device 110. In one embodiment, the storage device 118 includes models for modifying presentation of one or more content items presented by the display device 112. Additionally, the storage device 118 includes instructions for generating a user interface presenting content to a user via the display device 112, as well as instructions describing an application capturing information describing user interaction with the user interface. In some embodiments, the storage device 118 also includes one or more advertisements for presentation to a user via the user interface. Alternatively, the storage device 118 includes information identifying an entity external to the client device 110 to which information describing interaction with the user interface is communicated; the entity external to the client device 110 selects one or more advertisements for presentation via the user interface and communicates the selected advertisements to the client device 110 for presentation. The entity external to the client device 110 may also determining amounts of compensation charged to advertisers based at least in part on information from the client device 110 describing interaction with the user interface. Selection and pricing of advertisements is further described below in conjunction with FIGS. 2 and 3.

### Advertisement Selection Based on Inferred User Interest

FIG. 2 is a flowchart of one embodiment of a method for selecting advertisements for presentation to a user based on the user's interaction with a user interface presented by a client device 110. In some embodiments, the storage device 118 includes instructions that, when executed by the processor 116 display 205 a user interface including one or more advertisements via a display device 112 of the client device 110. For example, the user interface includes one or more content items and one or more advertisements in different regions of the display device 112. The user interacts with the user interface by accessing a region of the display device 112 using a pointer. For example, a pointer is a position on the display device 112 contacted by a user's finger or another type of physical stylus. As another example, a pointer is a position on the display device accessed by a user through another input device 114 of the client device 110.

The client device 110 identifies 210 movement of the pointer, as well as one or more attributes of the movement of the pointer, when an input is received from the user via an input device 114 based on a user interface presented by the display device 112. Example attributes of movement of the pointer include a direction of motion of the pointer, a velocity with which the pointer moves, a distance between the pointer and an advertisement displayed 205 by the user interface, and a distance between the pointer and a boundary of the display device 112. Examples of determining a direction, velocity, or distance associated with an input to a user interface are further described in International Patent Application No. PCT/ZA2012/000059, filed Sep. 21, 2012, which is hereby incorporated by reference in its entirety. Additional examples of determining a direction, velocity, or distance associated with an input are further described in International Patent Application No. PCT/IB2014/001818, filed May 12, 2014, which is hereby incorporated by reference in its entirety.

Based on the attributes, an application executing on the client device 110 and associated with the user interface determines 215 a measure of interest of the user in one or more advertisements presented by the user interface. The measure of user interest may be communicated to a content provider external to the client device 110, which selects one or more advertisements for presentation to the user based on the inferred user interest. Alternatively, one or more advertisements included in the storage device 118 may be selected and presented based at least in part on the inferred user interests.

In one embodiment, the measure of user interest in an advertisement presented by the user information is based at least in part on a direction of motion of the pointer relative to a region of the user interface displaying the advertisement. For example, a measure of user interest in an advertisement is proportional to a velocity with which the pointer moves toward a region of the display device 112 displaying 205 an advertisement. As another example, the measure of user interest in the advertisement is inversely proportional to a distance between the pointer and a region of the display device 112 displaying 205 the advertisement.

Conventionally, advertisements may be associated with one or more targeting criteria, which act as filters defined by an advertiser associated with an advertisement to identify users eligible to be presented with the advertisement. However, a user's measure of interest in one or more presented advertisements may be used as targeting criteria. Hence, determining 215 the user's measure of interest in an advertisement based the user's interaction with a user interface is used to select 220 one or more additional advertisements for presentation to the user. For example, an additional advertisement having at least a threshold number or percentage of characteristics matching characteristics of a presented advertisement with which the user has at least a threshold measure of interest is selected 220 for presentation to the user. In one embodiment, an application executing on the client device 110 ranks displayed advertisements based on their measures of user interest and selects a set of displayed advertisements having at least a threshold measure of user interest; one or more additional advertisements having at least a threshold number of characteristics matching characteristics of displayed advertisements in the set are selected 220 for presentation. Alternatively, displayed advertisements having at least a threshold measure of user interaction are identified and one or more additional advertisements having at least a threshold number of characteristics matching characteristics of the identified displayed advertisements are selected 220 for presentation. Example characteristics of an advertisement include: a location, an advertiser, a product, a topic, a keyword, and a time. Alternatively, information associating an advertisement with one or more additional advertisements is maintained by the client device 110 or by a content provider external to the client device 110; an advertiser or a content provider maintains the information associating the advertisement with one or more additional advertisements. For example, the information associates advertisements for one or more related products or services with an advertisement. In one embodiment, an additional advertisement associated with a displayed advertisement in which the user has at least a threshold measure of interest is selected 220 based on the information associating one or more additional advertisements with the displayed advertisement. For example, an advertisement for a rental car company is selected 220 for presentation to a user with at least a threshold interest in a presented advertisement for an airline.

Additionally, a user's determined measure of interest in a displayed advertisement provides additional information about the expected click-through rate (eCTR) of various advertisements (e.g., advertisements having at least a threshold number or percentage of characteristics matching characteristics of a displayed advertisement) which affects the expected value of presenting those advertisements. Thus, determining a measure of the user's interest in a displayed advertisement allows computation of a more accurate eCTR, which may be used to determine an expected value to a content provider for presenting an advertisement. For example, the measure of the user's interest in a displayed advertisement is communicated to a content provider, which determines a likelihood of the user interacting with one or more additional advertisements based on the measure of the user's interest in the displayed advertisement. Based on the likelihood of the user interacting with one or more additional advertisements and bid amounts associated with the one or more additional advertisements, expected values are determined for various additional advertisements. An expected value of an additional advertisement may be a product of a bid amount of the additional advertisement and the likelihood of the user interacting with the additional advertisement. Based on the expected values, one or more advertisements are selected 220. For example, additional advertisements having at least a threshold expected value are selected 220 or additional advertisements are ranked based on their expected values with additional advertisements having at least a threshold position in the ranking selected 220. Alternatively, an application executing on the client device 110 determines the expected values of additional advertisements based on the determined measures of user interest in displayed advertisements as described above.

Alternatively, based on the determined measures of user interest in displayed advertisements, a higher priority may be associated with an advertisement associated with a maximum measure of user interest or scores proportional to their associated user interest are associated with various advertisements. For example, scores are associated with various presented displayed advertisements are determined based on movement of the pointer towards different displayed advertisements. In one embodiment, a threshold measure of interest is specified by an advertiser or a content provider and a score is associated with advertisements for which the user has at least a threshold measure of interest. One or more additional advertisements may be selected for presentation to the user based at least in part on the scores associated with the presented advertisements. For example, one or more additional advertisements having one or more characteristics matching or similar to characteristics to displayed advertisements having at least a threshold score or having the highest scores are selected 220.

The one or more additional advertisements are displayed 225 to the user via the user interface. In one embodiment, the additional advertisements are displayed 225 when the user requests additional content via the user interface. For example, the one or more additional advertisements are displayed 225 when a request to update content presented by the user interface. Alternatively, one or more of the displayed advertisements are replaced by one or more of the additional advertisements, allowing the advertisements presented by the user interface to be dynamically updated based on the user's measures of interest in various advertisements. For example, displayed advertisements with which the user has less than a threshold measure of interest is replaced by one or more additional advertisements.

### Advertisement Pricing Accounting for User Interest in Advertisements

FIG. 3 is a flowchart of one embodiment of a method for selecting advertisements for presentation to a user based on the user's interaction with a user interface presented by a client device 110. When advertisements are presented to a user via a user interface that moves, resizes, or otherwise modifies presentation of one or more advertisements based on movement of a pointer representing a user interaction with the interface, prices charged to advertisers may be determined based in part on user interest in advertisement inferred from movement of the pointer. In contrast to a conventional cost per click pricing model, where an advertiser is not charged until an advertisement is accessed, using information representing a user's interest in an advertisement derived from pointer movement allows an advertiser to be charged if the movement of the pointer indicates at least threshold level of interest by the user in an advertisement associated with the advertiser. Additionally, unlike conventional cost per impression pricing, where advertisers are charged when an advertisement is presented, determining a user's interest in an advertisement from pointer movement limits an advertiser to being charged when the user indicates a threshold level of interest in an advertisement associated with the advertiser.

In one embodiment, a user interface displays 305 a plurality of advertisements to a user and movement of a pointer corresponding to a user interaction with the user interface is identified 310, as further described above in conjunction with FIG. 2. Based on the movement of the pointer, a display status of a presented advertisement is modified 315. A display status associates one or more display characteristics with an advertisement. Examples of a display status include a size of an advertisement, a position of an advertisement in the user interface, a color in which the advertisement is presented, a brightness with which the advertisement is presented, a boundary associated with selection of an advertisement, or other suitable characteristics of the displayed advertisement.

For example, a measure of interest of the user in an advertisement is determined based on the movement of the pointer relative to a region of the user interface displaying 305 the advertisement, and the display status of the advertisement is modified 315 based on the measure of interest. Determination of a measure of interest in an advertisement is further described above in conjunction with FIG. 2. As an example, a size of an advertisement is increased if the user's measure of interest in the advertisement has at least a threshold value or has at least a threshold rate of increase. In some embodiments, different modifications to a display status are associated with different ranges of measures of interest. For example, a brightness of an advertisement is increased when the user's measure of interest in the advertisement is within a range of values and a size of the advertisement is increased when the user's measure of interest is within a different range of values. In various embodiments, a display status of an advertisement is modified to make the advertisement more visually prominent when the measure of interest in the advertisement is determined to increase, while the display status of the advertisement is modified to decrease visual prominence of the advertisement when the measure of interest in the advertisement decreases. Alternatively, the display status of an advertisement is modified 315 based on a distance between the pointer and a region of the display device displaying the advertisement, a velocity at which the pointer moves towards the region of the display device displaying the advertisement, or any other suitable attribute of the movement of the pointer.

Based on the modified display status of the advertisement, a pricing function is applied 320 to the advertisement to determine a price charged to an advertiser associated with the advertisement. The advertisement is associated with a bid amount, which specifies a maximum amount of compensation an advertiser associated with the advertisement will provide a content provider for presentation of the advertisement or for user interaction with the advertisement. Various pricing functions may be applied to an advertisement based on the advertisement's adjusted display status. For example, a scalar between 0 and 1 is determined based on a measure of user interest in the advertisement determined from the movement of the pointer; a bid amount associated with the advertisement is multiplied by the scalar to determine the price charged to an advertiser associated with the advertisement. As another example, the bid amount associated with the advertisement is charged to the advertiser if the pointer reaches a threshold distance from the advertisement. Alternatively, if the pointer reaches a threshold distance from the advertisement, the advertiser is charged a price based on a bid amount associated with the advertisement multiplied by a scalar value determined from the movement of the pointer towards the advertisement.

As an additional example of a pricing function, an advertiser associated with an advertisement having a maximum interest score or associated with an advertisement having a minimum distance from the pointer is charged the bid amount associated with the advertisement. In one embodiment, the user interface presents hierarchical content items, so that movement of the pointer accesses different levels of content items, and an advertiser is charged a price based on a level of the hierarchy that the user accesses. For example, different bid amounts may be associated with different levels of the hierarchy or a bid amount may be scaled by a value that is based at least in part on the level of the hierarchy that was accessed. Alternatively, an advertiser associated with an advertisement that is selected by the user is charged the bid amount associated with the selected advertisement; information determined from the movement of the pointer may be used to determine when an advertisement is selected. In other embodiments, alternative or additional pricing functions may be applied. An advertiser associated with an advertisement is then charged 325 the price determined by application of the pricing function.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
displaying a user interface including one or more advertisements to a user via a client device;
identifying a movement of a pointer within the user interface;
for each of the one or more of the advertisements, determining a measure of interest of the user in the advertisement based at least in part on the identified movement of the pointer with respect to a location of the advertisement in the user interface;
selecting an additional advertisement for presentation to the user based on one or more of the determined measures of interests in one or more of the displayed advertisements; and
displaying the additional advertisement to the user.

2. The method of claim 1, wherein determining the measure of interest of the user in the advertisement based at least in part on the identified movement of the pointer with respect to the location of the advertisement in the user interface comprises:
determining the measure of interest of the user in the advertisement based on a velocity of movement of the pointer toward the location of the advertisement in the user interface.

3. The method of claim 2, wherein the measure of interest of the user in the advertisement is proportional to the velocity of movement of the pointer toward the location of the advertisement in the user interface.

4. The method of claim 1, wherein determining the measure of interest of the user in the advertisement based at least in part on the identified movement of the pointer with respect to the location of the advertisement in the user interface comprises:
determining the measure of interest of the user in the advertisement based on a distance between a location of the pointer in the user interface and the location of the advertisement in the user interface.

5. The method of claim 4, wherein the measure of interest of the user in the advertisement is inversely proportional to the distance between the location of the pointer in the user interface and the location of the advertisement in the user interface.

6. The method of claim 1, wherein selecting an additional advertisement for presentation to the user based on one or more of the determined measures of interests in one or more of the displayed advertisements comprises: ranking the one or more advertisements based at least in part on their associated measures of interest;
selecting a set of advertisements having at least a threshold position in the ranking; and
selecting an additional advertisement having at least a threshold number of characteristics matching characteristics of one or more advertisements in the set of advertisements.

7. The method of claim 1, wherein selecting an additional advertisement for presentation to the user based on one or more of the determined measures of interests in one or more of the displayed advertisements comprises:
identifying advertisements having at least a threshold measure of interest; and
selecting an additional advertisement having at least a threshold number of characteristics matching characteristics of one or more of the identified advertisements.

8. The method of claim 1, wherein selecting an additional advertisement for presentation to the user based on one or more of the determined measures of interests in one or more of the displayed advertisements comprises:
identifying an advertisement having at least a threshold measure of interest; and
selecting an additional advertisement that is associated with the identified advertisement.

9. The method of claim 1, wherein selecting an additional advertisement for presentation to the user based on one or more of the determined measures of interests in one or more of the displayed advertisements comprises:
determining expected values for one or more additional advertisements based at least in part on bid amounts associated with the additional advertisements and measures of interest in one or more presented advertisements having at least a threshold number of characteristics matching characteristics of one or more additional advertisements;
ranking the one or more additional advertisements based at least in part on the expected values; and
selecting an additional advertisement having at least a threshold position in the ranking.

10. The method of claim 1, wherein displaying the additional advertisement to the user comprises: replacing a displayed advertisement in which the user has less than a threshold measure of interest with the additional advertisement.

11. A method for pricing advertising for a user, the method comprising:
displaying a plurality of advertisements on a user interface;
identifying a movement of a pointer within the user interface;
modifying a display status of at least one of the displayed advertisements based on the identified pointer movement, where the display status includes at least one of a size, position, and selection boundary;
applying a pricing function to bid amounts associated with one or more of the displayed advertisements to determine a price for one or more of the displayed advertisements, the pricing function for a displayed advertisement based at least in part on the adjusted display status of the displayed advertisement; and
charging an advertiser associated with the displayed advertisement the determined price.

12. The method of claim 11, wherein modifying the display status of at least one of the displayed advertisements based on the identified pointer movement comprises:
determining a measure of interest of the user in an advertisement based at least in part on the identified movement of the pointer with respect to a location of the advertisement in the user interface; and
modifying the display status of the advertisement based at least in part on the determined measure of interest.

13. The method of claim 11, wherein the pricing function determines a value based on a measure of interest of the user in an advertisement based on the identified movement of the pointer and determines a price for the advertisement based on a bid amount of the advertisement and the value.

14. The method of claim 13, wherein the price for the advertisement is a product of the value and the bid amount of the advertisement.

15. The method of claim 13, wherein the value is between 0 and 1.

16. The method of claim 11, wherein the pricing function determines a price for an advertisement as a bid amount associated with the advertisement value if the identified movement of the pointer indicates the pointer is within a threshold distance of a region in which the advertisement is displayed.

17. The method of claim 11, wherein the pricing function determines a price for an advertisement as a bid amount associated with the advertisement value multiplied by a value if the identified movement of the pointer indicates the pointer is within a threshold distance of a region in which the advertisement is displayed
